(19) United States
(12) Patent Application Publication
(10) Pub. No.: US 2008/0037745 A1
(43) Pub. Date: Feb. 14, 2008

(54) Systems, Methods, And Media For Automated Conference Calling

(76) Inventors: Venkatesan Ramamoorthy, Round Rock, TX (US); Keith R. Walker, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/461,371

(22) Filed: Jul. 31, 2006

(51) Int. Cl. H04M 3/42

(52) U.S. Cl. 379/201.01; 379/202.01

(57) ABSTRACT

Systems, methods, and media for initiating a conference call with other communication devices are disclosed. Embodiments may include a method for initiating a conference call that may include receiving a verbal request to initiate a conference call and analyzing the request by parsing words in the request to detect one or more aliases in the request. Embodiments of the method may also include accessing one or more macros associated with each of the detected one or more aliases where each macro is adapted to dial a phone number. Embodiments of the method may also include initiating a conference call and performing a macro action for each of the associated macros to add participants associated with each detected alias to the initiated conference call. The aliases may be individual aliases having one associated macro or group aliases having a plurality of associated macros.

### FIELD OF INVENTION

The present invention is in the field of communication devices such as telephones and, in particular, to conference calling systems for initiating a conference call with other communication devices.

### BACKGROUND

Telephones typically represent one of the primary ways an individual can communicate with another person or an organization such as a business or governmental agency. Typically, a user must dial a telephone number to establish a connection with another telephone associated with that telephone number. In many instances, a user may desire to establish a conference call with multiple other users so that all parties to the conference call may participate in the conference call and interact with each other. Conference calls have accordingly become increasingly popular, particularly as the costs of calling long distance and establishing conference calls have dropped dramatically. While there is a significant demand for conference call capability for individual users, conference calling is particular useful in business environments as a means of facilitating collaboration between employees, customers, clients, or partners located throughout the world. A project manager may, for example, wish to establish a conference call with researchers at the research facility for his company, a key employee working at home, and programmers working overseas in order to conduct a meeting. As home offices, outsourcing, business collaboration, and other recent trends continue to progress and result in even more widely distributed workforces, the need for effective and efficient conference calling will likely continue to increase.

To establish a conference call, however, users must typically conduct a laborious, inefficient, and often frustrating process. Using the conference call capability of most telephone systems, a user may call a first telephone number of somebody they want to participate on the conference call and, after the first call is established, the user must press a key or combination of keys specified by the telephone provider to initiate the conference call. After pressing the appropriate keys, the user may then dial the second number and wait for the connection to be established. To add additional users to the conference call, the user must press the appropriate keys to add a new user and then dial their phone number. While the original user is going through this complicated process, users who have already been added to the conference call must typically wait for the set-up process to complete. Such a process can be highly inefficient as the initiating user must manually dial each phone number as well as the necessary keys to connect each other user to the conference call. This process is also prone to error because of the many manual key presses required, resulting in many chances to make mistakes by pressing the wrong key. If a user incorrectly dials one of the numbers, they must start the entire process over in some systems. This process becomes even more inefficient when larger conference calls are established that require many different phone numbers to be entered. International calls also exacerbate many of the problems with these systems, as international phone calls require more digits and have different rules, increasing the chance of error.

One solution to this problem is to establish a brokered conference call. For a brokered conference call, the originating user may communicate (such as via e-mail) information about a scheduled conference call to all potential users. The information may include a call-in telephone number, a bridge number, password, scheduled time, etc. Each user may call the appropriate telephone number (which is operated by the broker of conference call), enter any appropriate bridge numbers or passwords, and enter the phone call. While such a solution does eliminate or reduce the effect of many of the potential mistakes of a non-brokered conference call, it does suffer from some limitations. First, it requires the use of a broker and the potential necessity of paying that broker. Additionally, the originating user must distribute information about the conference call to the other users, resulting in each user having to keep track of the conference call information (and providing additional complications for those users who are traveling and who are away from their office). Each user must also still manually dial to enter the conference call. There is, therefore, a need for an effective and efficient solution for initiating a conference call with other communication devices.

### SUMMARY OF THE INVENTION

The problems identified above are in large part addressed by systems, methods, and media for initiating a conference call with other communication devices. Embodiments may include a method for initiating a conference call that may include receiving a verbal request to initiate a conference call and analyzing the request by parsing words in the request to detect one or more aliases in the request. Embodiments of the method may also include accessing one or more macros associated with each of the detected one or more aliases where each macro is adapted to dial a phone number. Embodiments of the method may also include initiating a conference call and performing a macro action for each of the associated macros to add participants associated with each detected alias to the initiated conference call. Further embodiments of the method may include receiving or generating one or more macros. The aliases may be individual aliases having one associated macro or group aliases having a plurality of associated macros.

Another embodiment provides a machine-accessible medium containing instructions effective, when executing in a data processing system, to cause the system to perform a series of operations for initiating a conference call. The series of operations may generally include receiving a verbal request to initiate a conference call and analyzing the request by parsing words in the request to detect one or more aliases in the request. Embodiments may also include a series of operations for accessing one or more macros associated with each of the detected one or more aliases. Embodiments may also include a series of operations for initiating a conference call and performing a macro action for each of the associated macros to add participants associated with each detected alias to the initiated conference call. Further embodiments may include a series of operations for receiving or generating one or more macros.

A further embodiment provides a conference calling module to establish a conference call. The conference calling module may include an interface to receive a verbal request to initiate a conference call and a conference call initiation module to initiate a conference call in response to receipt of the request by the interface. Embodiments of the conference calling module may also include a request parser module to analyze the request by parsing words in the request to detect one or more aliases and a macro handler module to access one or more macros associated with each of the detected aliases and to perform a macro action for each of the associated macros to add participants associated with each detected alias to the initiated conference call. The aliases may include one or more of an individual alias or a group alias.

### BRIEF DESCRIPTION OF THE DRAWINGS

Aspects of certain embodiments of the invention will become apparent upon reading the following detailed description and upon reference to the accompanying drawings in which, like references may indicate similar elements:

FIG. 1 depicts an environment for an automated conference call system with a communication device having a conference calling module according to some embodiments;

FIG. 2 depicts an environment for an automated conference call system with a communication device interacting with a conference calling server having a remote conference calling module according to some embodiments;

FIG. 3 depicts a conceptual illustration of software components of a conference calling module according to some embodiments;

FIG. 4 depicts a conceptual illustration of software components of a remote conference calling module according to some embodiments;

FIG. 5 depicts an example of a flow chart for receiving a request to initiate a conference call and initiating the conference call according to some embodiments; and

FIG. 6 depicts an example of a flow chart for generating macros according to some embodiments.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The descriptions below are designed to make such embodiments obvious to a person of ordinary skill in the art.

Generally speaking, systems, methods, and media for initiating a conference call with other communication devices are disclosed. Embodiments may include a method for initiating a conference call that may include receiving a verbal request to initiate a conference call and analyzing the request by parsing words in the request to detect one or more aliases in the request. Embodiments of the method may also include accessing one or more macros associated with each of the detected one or more aliases where each macro is adapted to dial a phone number. Embodiments of the method may also include initiating a conference call and performing a macro action for each of the associated macros to add participants associated with each detected alias to the initiated conference call. Further embodiments of the method may include receiving or generating one or more macros. The aliases may be individual aliases having one associated macro or group aliases having a plurality of associated macros.

As will be described in more detail subsequently, the methodology of the disclosed embodiments may provide for an efficient and effective mechanism for initiating a conference call with other communication devices. By utilizing the disclosed methodology, a user may verbally initiate a conference call and speak the name of the participants (or groups of participants). The disclosed system may then determine the macros associated with each of the participants and then perform each macro to add the participants to the conference call. The macros, which may be created, shared, and distributed by users, may contain an indication of the phone number for a user. Users may thus state their desired participants (using an alias for each) for a conference call and the disclosed system may convert the spoken instructions to a series of macros that, when executed, will add each participant to the conference call automatically. A user, for example, may state “Conference call Jim, Steve, and Bob” and the disclosed system may parse the request and automatically establish a conference call with each, eliminating the need to manually enter each recipient and reducing the possibility of error.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

While specific embodiments will be described below with reference to particular configurations of hardware and/or software, those of skill in the art will realize that embodiments of the present invention may advantageously be implemented with other substantially equivalent hardware and/or software systems. The invention can take the form of an entirely hardware embodiment, an entirely software embodiment or an embodiment containing both hardware and software elements. In a preferred embodiment, the invention is implemented in software, which includes but it not limited to firmware, resident software, microcode, etc.

Aspects of the invention described herein may be stored or distributed on computer-readable medium as well as distributed electronically over the Internet or over other networks, including wireless networks. Data structures and transmission of data (including wireless transmission) particular to aspects of the invention are also encompassed within the scope of the invention. Furthermore, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Each software program described herein may be operated on any type of data processing system, such as a personal computer, server, etc. A data processing system suitable for storing and/or executing program code may include at least one processor coupled directly or indirectly to memory elements through a system bus. The memory elements may include local memory employed during execution of the program code, bulk storage, and cache memories which provide temporary storage of at least some program code in order to reduce the number of times code must be retrieved from bulk storage during execution. Input/output (I/O) devices (including but not limited to keyboards, displays, pointing devices, etc.) may be coupled to the system either directly or through intervening I/O controllers. Network adapters may also be coupled to the system to enable the data processing system to become coupled to other data processing systems or remote printers or storage devices though intervening private or public networks, including wireless networks. Modems, cable modems and Ethernet cards are just a few of the currently available types of network adapters.

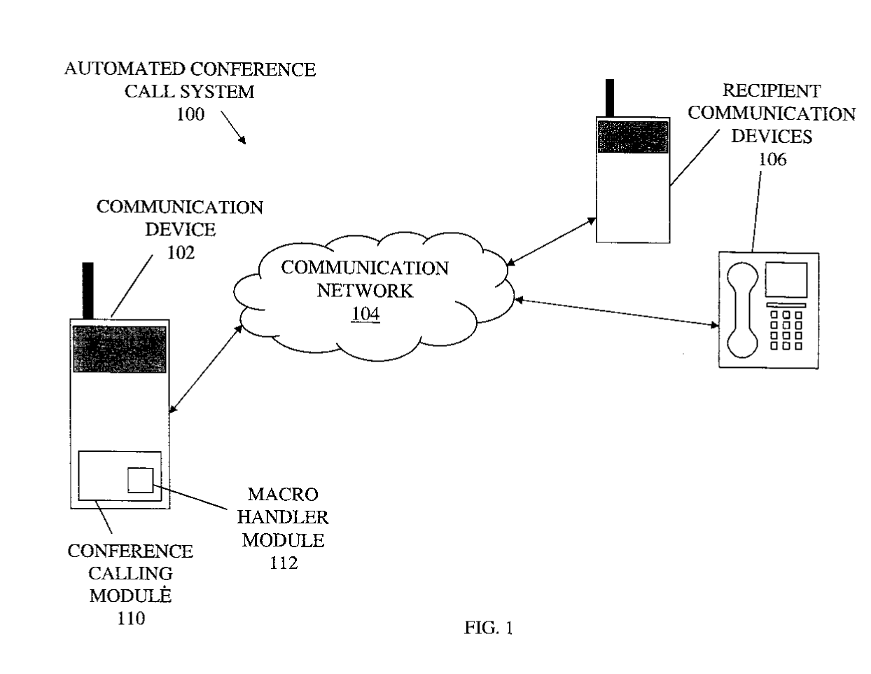

Turning now to the drawings, FIG. 1 depicts an environment for an automated conference call system with a communication device having a conference calling module according to some embodiments. The disclosed automated conference call system 100 includes a communication device 102 in communication with one or more recipient communication devices 106 via communication network 104. As will be described in more detail, a user of the communication device 102 may verbally request establishment of a conference call with one or more recipient communication devices 106 by speaking aliases for the users of the recipient communication devices 106. The communication device 102 may parse the user's request and determine macros associated with each alias, and perform the macros to add the requested participants to a conference call. The user may thus advantageously avoid having to manually input phone numbers for each participant of the phone call and various codes, passwords, or other information.

Communication devices 102 may include any devices adapted to communicate with recipient communication devices 106 via communication network 104. In some embodiments, a communication device 102 may be adapted to communicate via a phone connection (i.e., voice connection) of a communication network 104 with a recipient communication device 106. In other embodiments, a communication device 102 may communicate with a remote recipient communication device 106 via an Internet connection, such as via a Voice over Internet Protocol (VoIP) or other Internet telephony connection. Example communication devices 102 include mobile phones (such as cellular phones, satellite phones, or car phones) or traditional telephones (that connect to a telephone jack). Other example communication devices 102 may also include a personal computer with an Internet or other network connection that is adapted to allow voice communications, such as using a VoIP or other Internet telephony connection, or a voice communication-enabled personal digital assistant (PDA), automobile-based wireless device, wearable computer system, or other wireless communication device. Similarly, recipient communication devices 106 may be any devices adapted to communicate with a communication device 102 and similar devices are suitable for use as a recipient communication device 106 and the description will not be repeated in the interest of brevity.

The communication network 104 may include any data communication channel (or combinations of channels) that allows voice communication between a communication device 102 and a recipient communication device 106. Example communication networks 104 include the Internet, an intranet, a local area network (LAN), a wide area network (WAN), an Ethernet network, wireless network, or telephone network (such as a cellular network). In one example where communication network 104 includes a cellular network, the communication device 102 may be in wireless communication with a base station as part of the communication network 104, which in turn may be in communication with a mobile switching center, gateway mobile switching center (GMSC), or other elements of a cellular network (and all part of the communication network 104). In other embodiments, a communication network 104 may include both a wireless network and a telephone network in communication via a GMSC. Those skilled in the art will recognize, however, that other types of data communication channels included in the communication network 104 without departure from the scope and spirit of the invention.

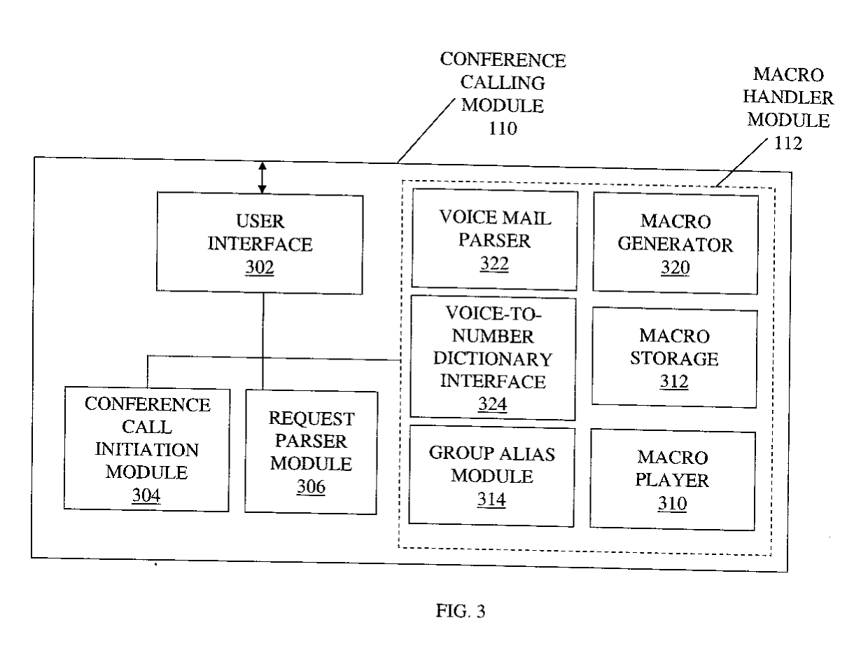

The communication device 102 may include a conference calling module 110 to receive and process requests to initiate a conference call and to initiate the conference call, add participants, etc. The conference calling module 110, as will be described in more detail in relation to FIG. 3, may receive a verbal request from a user to initiate a conference call. The verbal request may include one or more aliases representing desired participants in the conference call to be initiated. The aliases may each represent individuals or groups of individuals and each alias may be associated with a macro. The conference calling module 110 may parse the request by parsing words in the request to detect any aliases. The macro handler module 112 of the conference calling module 110 may access any macros associated with each detected alias and may also perform a macro action for the associated macros to add the desired participants to the initiated conference call.

By using the disclosed system, a user may efficiently initiate a conference call with a plurality of desired participants. The user may verbally request participants using their communication device 102 by speaking an alias for each participant. The conference calling module 110 may analyze the spoken aliases and automatically configure a conference call with all of the participants. The user may also utilize group aliases that represent a group of potential participants, providing further efficiencies. A user may request a conference call, for example, by saying “Conference in John, Stacy, and the Design Team” and the disclosed system may parse each alias (by detecting the alias, such as John) and determining the macros (i.e., the phone numbers) associated with the alias. In this example, the disclosed system may initiate a conference call and then perform macros to call John's phone number, Stacy's phone number, and the phone number of every person on the Design Team. A user may thus efficiently configure a conference call without having to dial in each phone number, provide complicated conference calling information, etc.

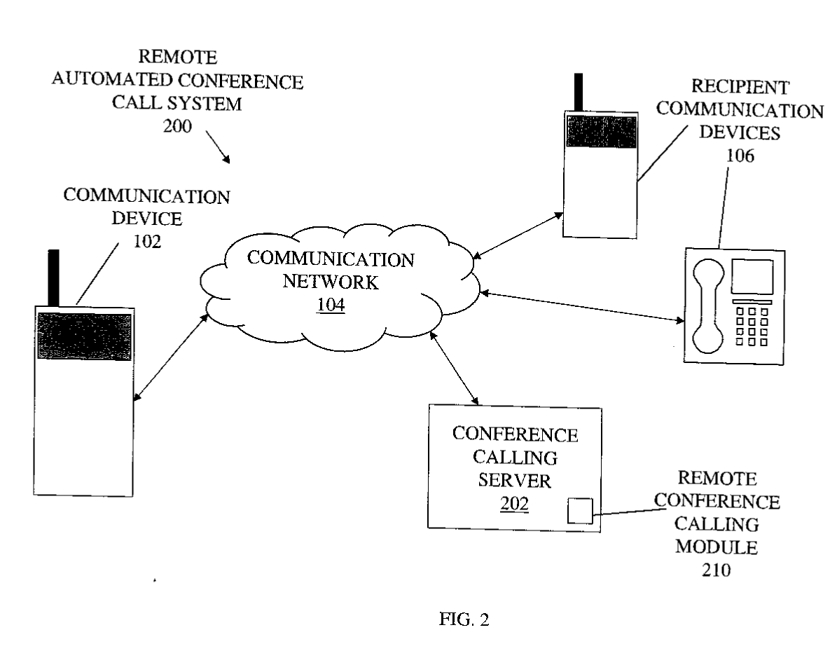

FIG. 2 depicts an environment for an automated conference call system with a communication device interacting with a conference calling server having a remote conference calling module according to some embodiments. The disclosed remote automated conference call system 200 includes a communication device 102 in communication with one or more recipient communication devices 106 via communication network 104. The remote automated conference call system 200 also includes a conference calling server 202 with a remote conference calling module 210. The remote automated conference call system 200 includes some of the same components as the automated conference call system 100 of FIG. 1 and the description of those components will not be repeated in the interest of brevity. In the remote automated conference call system 200, however, the communication device 102 need not have a conference calling module 110, allowing the remote automated conference call system 200 to provide conference calling functionality according to the disclosed embodiments to legacy systems or other communication devices 102 without conference calling modules 110. As will be described in more detail, the conference calling server 202 may provide for receiving and processing verbal requests for conference calling as well as initiating a conference call with the requested participants.

The conference calling server 202 may be a server or other computer system that executes all or part of a conference calling system and is adapted to communicate with one or more communication devices 102. The conference calling server 202 may be one or more of any type of computer system, including servers, personal computers, workstations, mainframe computers, desktop computers, or the like. In one embodiment, the conference calling server 202 is an International Business Machines (IBM) IBM® eServer or similar server having one or more processors, or threads of processors, executing software and/or one or more state machines coupled with data storage devices such as random access memory (RAM), read only memory (ROM), flash memory, compact disk drives, hard drives, and the like. The conference calling server 202 may be integrated with other servers, such as a voice mail server, a server operated by a telephone service provider, a server used for VoIP telephony, or other servers. The remote conference calling module 210 may be software executing on the conference calling server 202 according to some embodiments.

The remote conference calling module 210 of the conference calling server 202 may receive requests that users make for a conference call from the communication device 102 and via communication network 104. The communication device 102 may pass the user's verbal request to the conference calling server 202 for processing. In some embodiments, a user may utter a verbal command, dial a specific number, and/or enter one or more key presses to activate conference calling functionality and effectively ‘log in’ to the conference calling server in a fashion similar to logging in to a remote voice mail system. Once the user is logged in, they may then make their verbal request (using their communication device 102) within the conference calling system. As described previously, the verbal request may include one or more aliases representing desired participants in the conference call to be initiated, and each alias may represent individuals or groups of individuals and each alias may be associated with a macro.

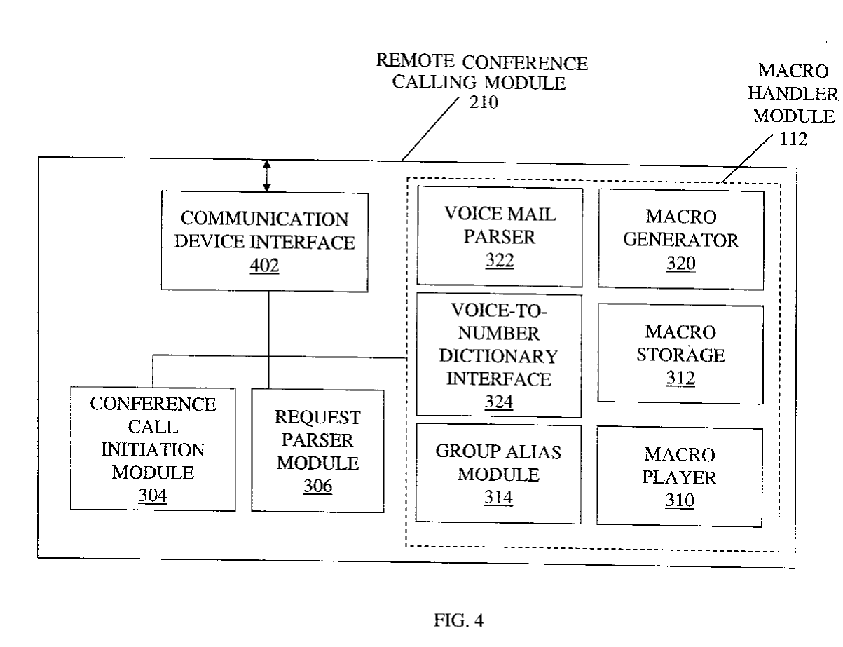

The remote conference calling module 210, as described in more detail in relation to FIG. 4, may process the verbal request by parsing words in the request to detect any aliases and may also initiate the conference call using any type of conference call logic. The remote conference calling module 210 may access any macros associated with each detected alias and may also perform a macro action for the associated macros to add the desired participants to the initiated conference call by dialing or facilitating dialing of the phone numbers as part of performing the macros.

The disclosed remote conference calling module 210 and conference calling server 202 may thus provide conference call ability to users of any communication device 102, eliminating the need to modify the communication device 102. The disclosed conference calling server 202 may also thus provide the conference calling service to a plurality of communication devices 102, including in some embodiments by handling requests from different communication devices 102 simultaneously. The remote conference calling module 210 may also facilitate sharing of macros by different users. The remote conference calling module 210 may store, for example, macros associated with a particular group, such as macros usable by members of an organization. A user could make a verbal request to “Conference in John, Glenda, and Brent in Legal” where the “Brent in Legal” alias is an alias that calls a macro useable by any in the organization.

FIG. 3 depicts a conceptual illustration of software components of a conference calling module according to some embodiments. One or more of the software components of the conference calling module 110 may execute on a processor of a communication device 102. As described previously, the conference calling module 110 may receive and parse a verbal request for a conference call and may also initiate the conference call with the requested participants. The conference calling module 110 may include a user interface 302, a conference call initiation module 304, and a request parser module 306 in addition to the macro handler module 112.

The user interface 302 may facilitate interaction between a user of the communication device 102 and components of the conference calling module 110. The user interface 302 may accomplish its tasks by interfacing with user interface hardware of the communication device 102, such as keypads or microphones for user input and speakers and displays for user output. The user interface 302 may receive input from the user, for example, such as key presses or verbal requests. The user interface 302 may also provide information to be output to the user, such as acknowledgements, a dynamic list of connected users, a dynamic list of unconnected users, or requests to repeat all or part of the verbal request.

The conference call initiation module 304 may initiate a conference call upon request by a user. In some embodiments, the conference call initiation module 304 may initiate the conference call by requesting initiation from a separate conference calling application outside of the conference calling module 110. The conference call initiation module 304, or a separate application that it calls, may use any type of conference calling logic now known or later developed. The conference call initiation module 304 may interact with the macro handler module 112 to ensure that additional participants are added to the initiated conference call as their associated macros are executed.

The request parser module 306 may parse the request received by the user interface 302 by parsing words in the request to detect any aliases. In some embodiments, the request parser module 306 may use voice recognition software to parse the verbal request and to extract words (or letters, numbers, or characters) from the request. The request parser module 306 may then determine which parsed words correspond to aliases (whether they are individual aliases or group aliases). Recognition of spoken letters and words is known in the art and one of ordinary skill in the art will also recognize that the request parser module 306 may utilize algorithms presently known or later developed to parse letters, numbers, and words based on accents, different voices, languages, dictionaries, etc. The request parser module 306 may begin its parsing, in some embodiments, after detection of a signal that a list of aliases is beginning. The signal may include a key press by the user, a command word, or other indication. A user, for example, may use “participants” as a keyword in a request such as “Include participants Larry, David, and Clara in the call”, providing a signal to the request parser module 306 to begin extracting aliases immediately after the keyword “participants”.

The macro handler module 112 of the conference calling module 110 may access any macros associated with each detected alias and may also perform a macro action for the associated macros to add the desired participants to the initiated conference call. The macro handler module 112 may include a macro player 310, macro storage 312, and a group alias module 314 for handling macros and a macro generator 320, voice mail parser 322, and voice-to-number dictionary interface 324 for generating or creating macros.

Upon request, the macro player 310 may access a macro stored in macro storage 312 and may then perform a macro action by executing the macro. By performing the macro action, the macro player 310 may dial the phone number(s) contained within the macro and, in possible conjunction with the conference call initiation module 304, may add the participants at those phone numbers to the initiated conference call. As discussed previously, the macros accessed and played by the macro player 310 may be those macros associated with each alias detected by the request parser module 306. Individual aliases may have one associated macro while group aliases may have two or more associated macros in some embodiments. The macro player 310 may also utilize the group alias module 314 to determine multiple macros that are associated with a particular group alias 314. The group alias module 314 may include an indication of one or more group aliases where each group alias may contain references to one or more individual aliases, group aliases, or macros. Group aliases may be user-defined or may be provided by an organization, such as an employer. In one example, a user may define group aliases for a project team on which they are working, their bosses, their group, or any other combination so that they may quickly and conveniently conference those groups. Each group alias in this example may include either an identification of the associated macro or an alias.

The macro generator 320 may generate or receive macros for storage in macro storage 312 and later execution by the macro player 310. A macro for a particular phone number may, when executed or played, dial the phone number to establish a phone connection. The macro generator 320 may generate the macros based on the determined phone number by utilizing the determined phone number in full or modifying the determined phone number in some way. The macro generator 320 may thus adjust the extracted numbers according to any dialing rules of the user or other methodologies, such as default settings. In one example, the macro generator 320 may truncate a determined phone number of ‘1-512-555-8888’ if that number is a local number and the ‘1-512’ portion need not be dialed. In another example, the macro generator 320 may add additional numbers to a determined phone number, such as by adding an area code, a leading ‘1’, a number such as ‘9’ to reach an outside line, a calling card code, etc. In some embodiments, the macro generator 320 may receive a macro from another source, such as a centralized macro database of an organization, a contact list program, or other source. Macros may thus provide significant flexibility as they may be generated, exchanged, transferred, etc. by users. A user of a communication device 102 may have access to, for example, everyone in her contact list so that the user may speak the name from the contact list when initiating a conference call to add the contact as a participant. In another example, a user may receive a group of macros associated with a group alias from their project leader so that they can use a group alias for their project to conference their entire project team.

In other embodiments, the macro generator 320 may generate macros. In some embodiments, the macro generator 320 may collaborate with a voice mail parser 322 to generate macros based on phone numbers recorded in a voice mail message. The voice mail parser 322 may analyze a voice mail message to detect spoken phone numbers within the message after which the macro generator 320 may generate macros based on the detected phone numbers. In some embodiments, the voice mail parser 322 may use voice recognition software to search for trigger words in the voice mail message. Trigger words may be any words or combination of words that provide an indication that a spoken phone number may soon follow. An example trigger word would be ‘call me’, such as if someone leaves a message saying ‘call me at 512-555-7777’. In this example, the voice mail parser 322 may analyze the voice mail message until it finds the trigger word ‘call me’ and then continue to apply voice recognition analysis to detect the phone number spoken after ‘call me’. Other potential trigger words could be ‘phone’, ‘number’, or any other words a provider of a number extractor 110 may deem to be indications of an upcoming phone number. Using trigger words may reduce the possibility of mistake (e.g., spoken numbers that are not phone numbers) and may also provide an association to a name or location when multiple phone numbers are contained within the message. In other embodiments, the voice mail parser 322 may simply apply voice recognition analysis to the entire message to extract any spoken phone numbers without using trigger words. The voice mail parser 322 may also recognize, analyze, and convert spoken phone numbers that utilize letters, such as 1-800-IBM-HELP or 1-800-GO-FEDEX.

In other embodiments, the macro generator 320 may collaborate with a voice-to-number dictionary interface 324 to generate macros based on phone numbers stored in a voice-to-number dictionary. A voice-to-number dictionary may be transmitted by some communication devices 102 along with a voice mail message. The voice-to-number dictionary may include an indication of phone numbers and associated words for the recipient to speak. When a user of a compatible recipient communication device 106 reviews their voice mail message at a later time, they may speak one of the associated words and the associated phone number will be determined, providing the user with the opportunity of calling, storing, deleting, or performing other action with the phone number.

FIG. 4 depicts a conceptual illustration of software components of a remote conference calling module according to some embodiments. One or more of the software components of the remote conference calling module 210 may execute on a processor of a conference calling server 202. As described previously, the remote conference calling module 210 may receive and parse a verbal request for a conference call received from a communication device 102 and may also initiate the conference call with the requested participants on recipient communication devices 106. Some of the components of the remote conference calling module 210 of FIG. 4 may be substantially similar to the components of the conference calling module 110 of FIG. 3 and the description of those components will not be repeated in the interest of brevity.

The communication device interface 402 of the remote conference calling module 210 may receive verbal requests from users for a conference call from a communication device 102 via communication network 104. As described previously, the verbal request may include one or more aliases representing desired participants in the conference call to be initiated, and each alias may represent individuals or groups of individuals and each alias may be associated with a macro. The communication device interface 402 may facilitate communication to and from other components of the remote conference calling module 210. In one example, the communication device interface 402 may pass received verbal requests to a request parser module 306 for processing.

The remote conference calling module 210 may process and handle verbal requests from a plurality of users and communication devices 102, including handling such requests simultaneously in some embodiments. For each request, the request parser module 306 may parse words in the request to detect any aliases, the conference call initiation module 304 may initiate the conference call, and the macro handler module 112 may access any macros associated with each detected alias and perform a macro action for the associated macros to add the desired participants to the initiated conference call. Macro storage 312 may store macros for a plurality a users, facilitating potential sharing of macros by users or groups of users.

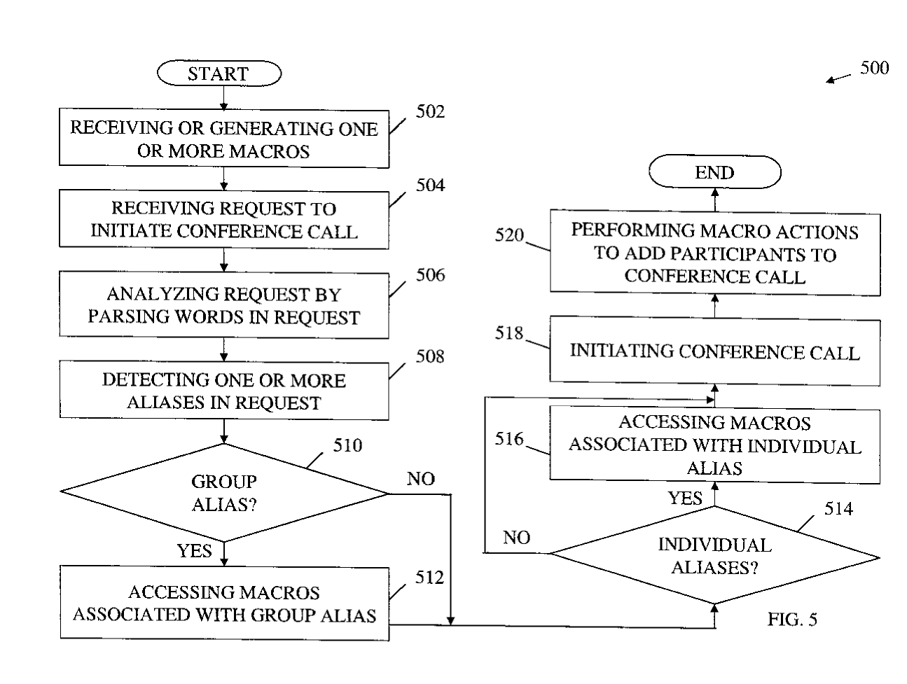

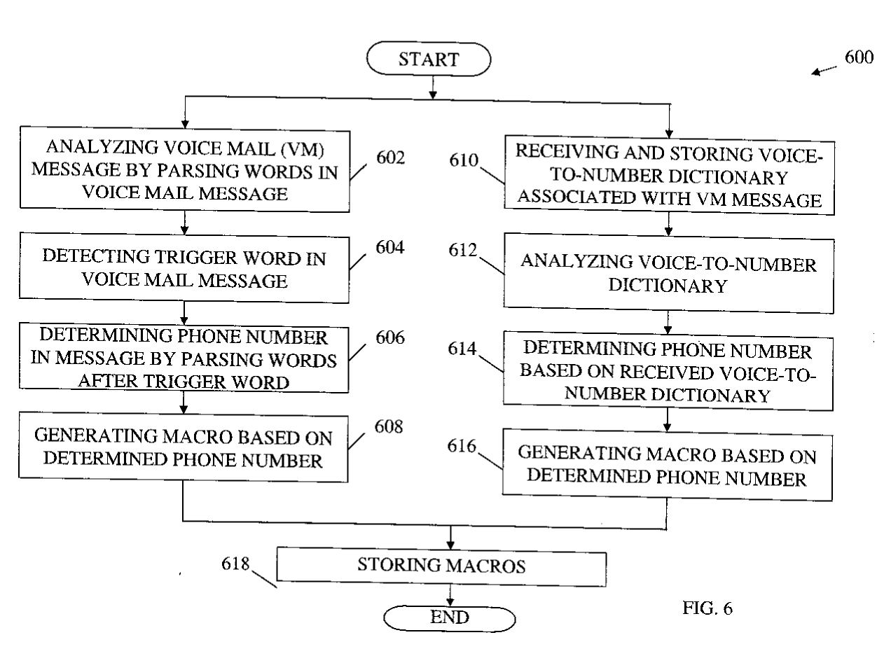

FIG. 5 depicts an example of a flow chart 500 for receiving a request to initiate a conference call and initiating the conference call according to some embodiments. The method of flow chart 500 may be performed, in one embodiment, by components of a conference calling module 110 (as described herein) or a remote conference calling module 210. Flow chart 500 begins with optional element 502, where conference calling module 110 may receive and/or generate one or more macros. The conference calling module 110 may receive macros from any source, such as by a user inputting a macro or downloading a macro from an e-mail or website. The conference calling module 110 may also generate macros, such as by generating a macro in response to a user inputting a phone number and alias. Other examples of generating a macro are described in relation to FIG. 6 subsequently.

The conference calling module 110 may receive a verbal request to initiate a conference call with particular participants at element 504. As described previously, the verbal request may include one or more aliases representing individuals or groups of individuals the requesting user desires to participate in the conference call. In some embodiments, a request to initiate a conference call may precede the verbal description of aliases, such as when a key press or command word may initiate conference calling logic. The user may press a combination of keys, for example, to indicate that they desire to initiate a conference call and may then speak the aliases of individuals to be included in the call. After receiving the verbal request, the conference calling module 110 may at elements 506, 508 analyze the request by parsing words in the request to detect any aliases in the request.

If the conference calling module 110 detects any group aliases at element 508, the conference calling module 110 may determine at decision block 510 to proceed to element 512, where the macro handler module 112 may access the macros that are associated with each detected group alias. Each group alias may be associated with a plurality of macros, each of which may call a particular phone number when the macro is played. Group aliases provide an effective means to quickly add multiple phone numbers to a conference call. If the conference calling module 110 detects any individual aliases at element 508, the conference calling module 110 may determine at decision block 514 to proceed to element 516, where the macro handler module 112 may access the macros that are associated with each detected individual alias.

After accessing the macros associated with any detected aliases in the verbal request, the method of flow chart 500 may continue to element 518, where the conference call initiation module 304 may initiate a conference call using any methodology. At element 520, the macro handler module 110 may perform macro actions for each of the associated macros to add the desired participants to the initiated conference call, after which the method of flow chart 500 may terminate. At elements 518 and 520, the conference call initiation module 304 and the macro handler module 110 may split their functions in any way to collaborate to establish the conference call with the desired participants. In one example, the macro handler module 110 performs each macro action sequentially after the conference call is initiated. After the macro handler module 110 has performed all of the associated macro actions, each desired participant of the conference call should be successfully connected to the call. In some situations individuals may not be successfully connected, such as when their phone service is unavailable, they do not answer the phone, etc.

FIG. 6 depicts an example of a flow chart 600 for generating macros according to some embodiments. The method of flow chart 600 may be performed, in one embodiment, by components of a macro handler module 112, such as by a macro generator 320 in conjunction with the voice mail parser 322 and/or the voice-to-number dictionary interface 324. Flow chart 600 depicts two examples of a process by which macros may be generated, one example depicted by the path starting at element 602 and the second example depicted by the path starting at element 610. Either or both of these paths (as well as other methodologies, such as receiving user input and generating macros based on the input) may be used by a macro generator 320 to generate macros.

The example starting at element 602 describes a methodology of analyzing a voice mail message and generating macros based on phone numbers included in the voice mail message. At element 602, a voice mail parser 322 may analyze a voice mail message by parsing the spoken words in the voice mail message. In some embodiments, the voice mail parser 322 may search for trigger words (as described previously) in the voice mail message, as depicted in element 604. The voice mail parser 606 may then determine a phone number within the voice mail message by parsing a series of words after the trigger word at element 606. Element 606 may be repeated until the entire voice mail message has been analyzed. The voice mail parser 322 may parse the words after a trigger word in a variety of ways. In some embodiments, the voice mail parser 322 may utilize voice recognition techniques to parse the words to determine a phone number, which may be useful if the caller spells out a phone number. The voice mail parser 322 may also determine a name associated with the phone number based on its parsing. In other embodiments, the voice mail parser 322 may parse a name and cross-reference the name with a name dictionary to see if the system has a phone number associated with that name. As an example, the voice mail parser 322 may parse a voice mail message that says ‘Please call me at 555-5555 or call Steve Johnson in Accounting’ by detecting the trigger word ‘call’ and associating the phone number ‘555-5555’ with the caller (because of ‘call me’) and may also detect the second trigger word of ‘call’ and parse the name ‘Steve Johnson’ by performing an information look-up in an internal corporate directory. After determining one or more phone numbers, the macro generator 322 may generate one or more macros for each determined phone number at element 608 and may also optionally store the generated macros in macro storage 312 at element 618, after which the method terminates. The voice mail parser 322 and macro generator 320 may thus step through a voice mail message to determine any phone numbers associated with the message and to generate a macro for each. The macro generator 320 may also associate an alias with each generated macro, such as by associating the spoken name (as part of the trigger) with the macro.

The example starting at element 610 describes a methodology for determining a phone number in a voice mail message based on a voice-to-number dictionary and generating a macro for the phone number. At element 610, the macro generator 320 may collaborate with a voice-to-number dictionary interface 324 to receive and store a voice-to-number dictionary associated with a voice mail message. The voice-to-number dictionary interface 324 may analyze the voice-to-number dictionary at element 612 and determine the phone number based on the received dictionary at element 614. In one example, the voice-to-number dictionary may include a phone number associated with Jim and a phone number associated with Steve and the voice-to-number dictionary interface 324 may determine the two phone numbers for the two individual aliases of Jim and Steve. After determining one or more phone numbers, the macro generator 320 may generate one or more macros for each determined phone number at element 616 and may also optionally store the generated macros in macro storage 312 at element 618, after which the method terminates.

It will be apparent to those skilled in the art having the benefit of this disclosure that the present invention contemplates methods, systems, and media for initiating a conference call with other communication devices. It is understood that the form of the invention shown and described in the detailed description and the drawings are to be taken merely as examples. It is intended that the following claims be interpreted broadly to embrace all the variations of the example embodiments disclosed.

What is claimed is:

1. A method for initiating a conference call, the method comprising:
receiving a verbal request to initiate a conference call;
analyzing the request by parsing words in the request to detect one or more aliases in the request;
accessing one or more macros associated with each of the detected one or more aliases, each macro being adapted to dial a phone number;
initiating a conference call; and
performing a macro action for each of the associated macros to add participants associated with each detected alias to the initiated conference call.

2. The method of claim 1, further comprising receiving one or more macros.

3. The method of claim 2, wherein receiving one or more macros comprises receiving a contact list having a plurality of macros.

4. The method of claim 1, further comprising generating one or more macros.

5. The method of claim 4, wherein generating one or more macros comprises:
analyzing a voice mail message by parsing words in the voice mail message;
determining one or more phone numbers associated with the voice mail message based on the analysis of the voice mail message; and
generating a macro based on each of the determined phone numbers.

6. The method of claim 5, wherein analyzing the voice mail message by parsing words in the voice mail message comprises detecting a trigger word in the voice mail message, and wherein further determining one or more phone numbers associated with the voice mail message comprises parsing words in the voice mail message after the detected trigger word.

7. The method of claim 5, wherein analyzing the voice mail message by parsing words in the voice mail message comprises analyzing a voice-to-number dictionary associated with the voice mail message, and wherein further determining one or more phone numbers associated with the voice mail message comprises determining one or more phone number associated with the voice mail message based on the associated voice-to-number dictionary.

8. The method of claim 1, wherein at least one detected alias is an individual alias, the individual alias having one associated macro.

9. The method of claim 1, wherein at least one detected alias is a group alias, the group alias having a plurality of associated macros.

10. The method of claim 1, wherein each macro is associated with one or more of an individual alias, multiple individual aliases, a group alias, multiple group aliases, or a combination of individual aliases and group aliases.

11. A machine-accessible medium containing instructions effective, when executing in a data processing system, to cause said data processing system to perform operations comprising:
receiving a verbal request to initiate a conference call;
analyzing the request by parsing words in the request to detect one or more aliases in the request;
accessing one or more macros associated with each of the detected one or more aliases, each macro being adapted to dial a phone number;
initiating a conference call; and
performing a macro action for each of the associated macros to add participants associated with each detected alias to the initiated conference call.

12. The machine-accessible medium of claim 11, further comprising receiving one or more macros.

13. The machine-accessible medium of claim 11, further comprising generating one or more macros.

14. The machine-accessible medium of claim 11, wherein at least one detected alias is an individual alias, the individual alias having one associated macro.

15. The machine-accessible medium of claim 11, wherein at least one detected alias is a group alias, the group alias having a plurality of associated macros.

16. A conference calling module system to establish a conference call, comprising:
an interface to receive a verbal request to initiate a conference call;
a conference call initiation module to initiate a conference call in response to receipt of the request by the interface;
a request parser module in communication with the interface to analyze the request by parsing words in the request to detect one or more aliases; and
a macro handler module in communication with the request parser module to access one or more macros associated with each of the detected aliases and to perform a macro action for each of the associated macros to add participants associated with each detected alias to the initiated conference call.

17. The system of claim 16, wherein the interface comprises a user interface to receive a verbal request from a user.

18. The system of claim 16, wherein the interface comprises a communication device interface to receive a verbal request from a communication device, and wherein further the conference calling module system is a remote conference calling system executing on a conference calling server.

19. The system of claim 16, wherein the macro handler module is further adapted to generate one or more macros based on a voice mail message.

20. The system of claim 16, wherein the detected one or more aliases include one or more of an individual alias or a group alias.
